(19) United States
(12) Patent Application Publication
(10) Pub. No.: US 2014/0058769 A1
(43) Pub. Date: Feb. 27, 2014

(54) SOCIAL NETWORK FOR TOUR PLANNING

(71) Applicants: Xinyu Zhang, Honolulu, HI (US); Hang Xie, Honolulu, HI (US)

(72) Inventors: Xinyu Zhang, Honolulu, HI (US); Hang Xie, Honolulu, HI (US)

(21) Appl. No.: 13/973,506

(22) Filed: Aug. 22, 2013

Related U.S. Application Data
(60) Provisional application No. 61/692,157, filed on Aug. 22, 2012.

(51) Int. Cl. G06Q 10/02; G06Q 50/00

(52) U.S. Cl. CPC G06Q 10/02; G06Q 50/01
USPC 705/5

(57) ABSTRACT

A social networking system server which includes a processor, wherein the processor utilizes computer readable program code to initiate, implement, and conclude, a travel plan. The computer readable program code comprising a series of computer readable program steps to effect coordinating a global, on-line social networking system (“SNS”). The computer readable program code further includes a series of computer readable program steps to effect initiating a travel plan for a first SNS member, purchasing goods on-line, implementing a tour plan, and concluding the tour plan.

### CROSS REFERENCE TO RELATED APPLICATIONS

This U.S. Non-Provisional Application claims priority to a U.S. Provisional Application having Ser. No. 61/692,157, filed Aug. 22, 2012, which is hereby incorporated by reference.

### FIELD OF THE INVENTION

The present application relates to a social networking system (“SNS”) and, a method using that SNS to plan a tour.

### BACKGROUND OF THE INVENTION

A travel agency's main function is to act as an agent, selling travel products and services on behalf of a supplier. In some countries, airlines have stopped giving commissions to travel agencies. Prior art travel services providers do not take advantage of pre-existing social networking platforms

### SUMMARY OF THE INVENTION

A social networking system server comprising a processor, a non-transitory computer readable medium, computer readable program code encoded in the non-transitory computer readable medium, wherein the wherein the processor utilizes the computer readable program code to design a travel plan, and implement and conclude a tour plan based upon the travel plan, is presented.

The computer readable program code comprises a series of computer readable program steps to effect coordinating a global, on-line social networking system (“SNS”) comprising one or more global lodging providers in on-line communication with the SNS server, one or more global travel services providers in on-line communication with the SNS server, one or more global rental vehicle service providers in on-line communication with the SNS server, one or more global catalog goods providers in on-line communication with the SNS server, and a plurality of individual SNN members in on-line communication with the SNS server.

The computer readable program code further comprises a series of computer readable program steps to effect initiating a travel plan for a first SNS member, purchasing goods on-line, implementing a tour plan, and concluding the tour plan.

A computer program product encoded in a non-transitory computer readable medium is presented, wherein a programmable computer processor can utilize the computer program product to initiate a travel plan, and implement and conclude a tour plan based upon the travel plan.

In certain embodiments, the computer program code comprises computer readable program code which causes the programmable computer processor to coordinate a global, on-line social networking system (“SNS”) comprising one or more global lodging providers in on-line communication with the SNS server, one or more global travel services providers in on-line communication with the SNS server, one or more global rental vehicle service providers in on-line communication with the SNS server, one or more global catalog goods providers in on-line communication with the SNS server, and a plurality of individual SNN members in on-line communication with the SNS server;

In certain embodiments, the computer program code comprises computer readable program code which causes the programmable computer processor to initiate a travel plan for a first SNS member, purchase goods on-line, implement a tour plan, and conclude the tour plan.

### BRIEF DESCRIPTION OF THE DRAWINGS

Implementations of the invention will become more apparent from the detailed description set forth below when taken in conjunction with the drawings, in which like elements bear like reference numerals.

FIG. 1A is a block diagram depicting an exemplary embodiment of Applicant's SNS;

FIG. 1B illustrates a plurality of on-line vendors and governmental agencies in on-line communication with Applicant's SNS server;

FIG. 2 is a diagram of an exemplary internet-enabled device for use in accessing Applicant's SNS;

FIG. 3 summarizes Applicant's method;

FIG. 4 summarizes certain steps of Applicant's method directed to initiating a travel plan;

FIG. 5 summarizes certain steps of Applicant's method directed to revising a Tour Plan;

FIG. 6 summarizes certain steps of Applicant's method directed purchasing supplies in accord with a Tour Plan;

FIG. 7 summarizes certain steps of Applicant's method directed to implementing a Tour Plan; and

FIG. 8 summarizes certain steps of Applicant's method directed to concluding a Tour Plan.

### DETAILED DESCRIPTION OF THE EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

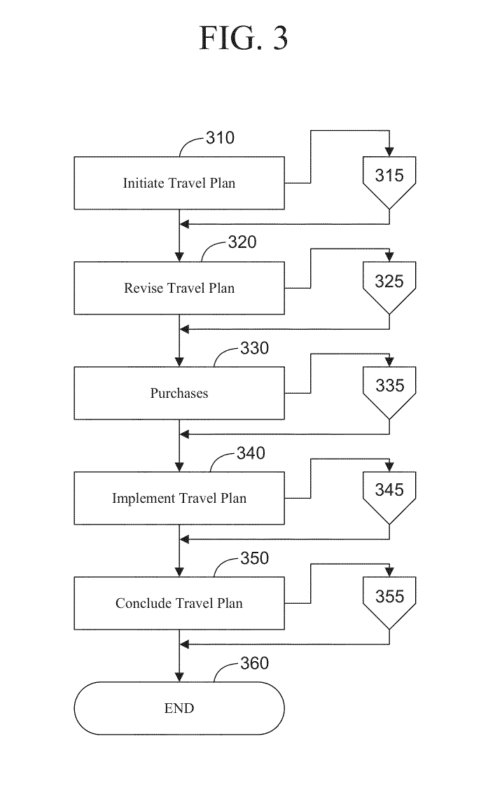

The schematic flow chart diagrams included are generally set forth as logical flow-chart diagrams (e.g., FIGS. 3-8). As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method (e.g., FIGS. 3-8). Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

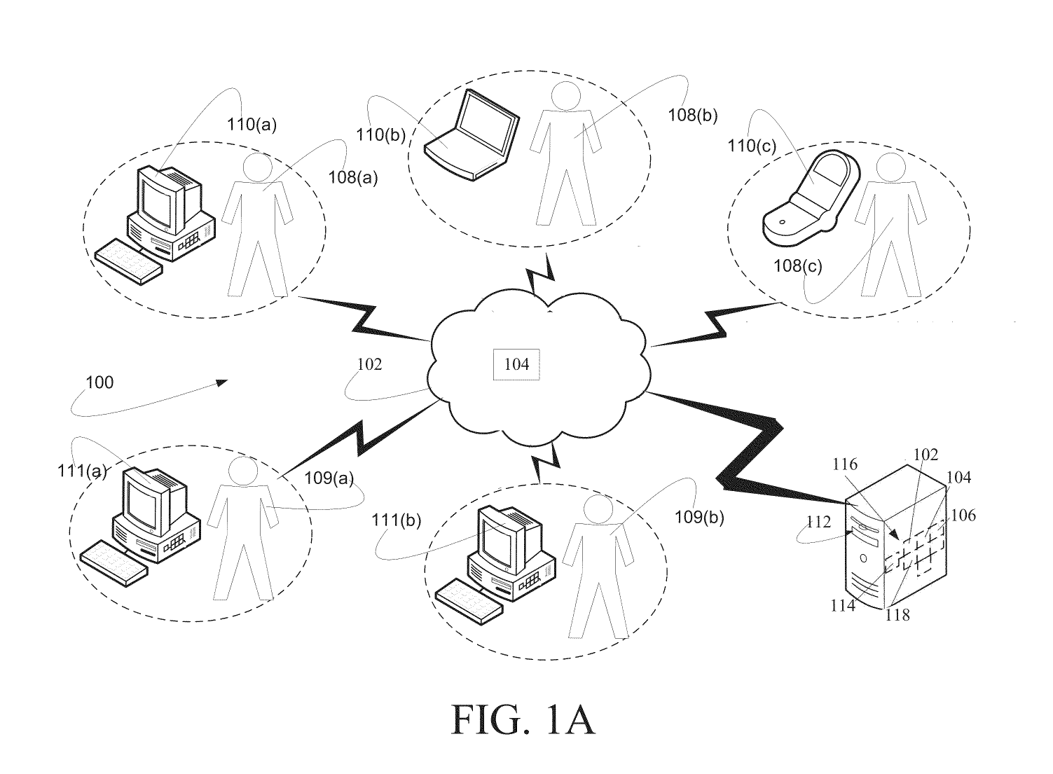

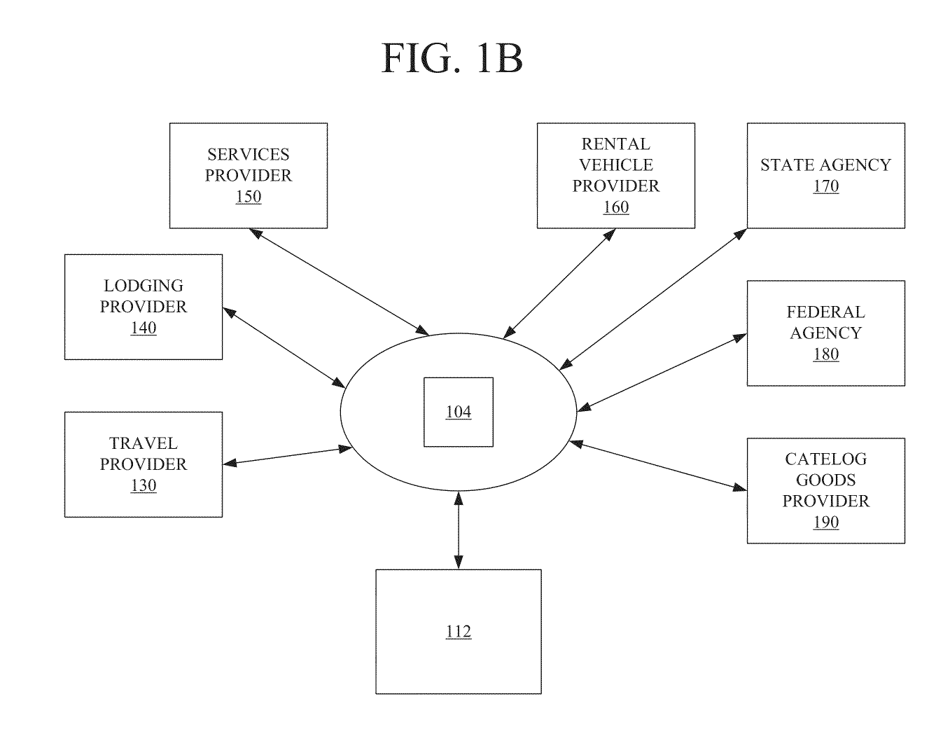

FIG. 1 illustrates an exemplary embodiment of Applicant's social networking system (“SNS”) 100. In certain embodiments, Applicant's method utilizes SNS 100 to initiate a travel plan, revise that travel plan, make purchases need for the travel plan, implement the travel plan, and eventually conclude the travel plan.

In the illustrated embodiment of FIG. 1A, a SNS subscriber, such as user 108(a) (or 108(b) or 108(c)), of Applicant's uses an internet-enabled device, such as apparatus 110(a), to access SNS server 112. In certain embodiments, each SNS subscriber pays a subscription fee. In certain embodiments, the subscription fee is paid monthly. In certain embodiments, a subscription fee is based upon SNS usage and services provided by the SNS to a subscriber.

Apparatus 110(a) (or 110(b) or 110(c)) may be any device capable of accessing a webpage, such as, and without limitation, a personal computer, laptop, tablet PC, cellular telephone, personal digital assistant (PDA), SmartPhone or similar device. An exemplary embodiment of apparatus 110(a) is depicted in FIG. 1B.

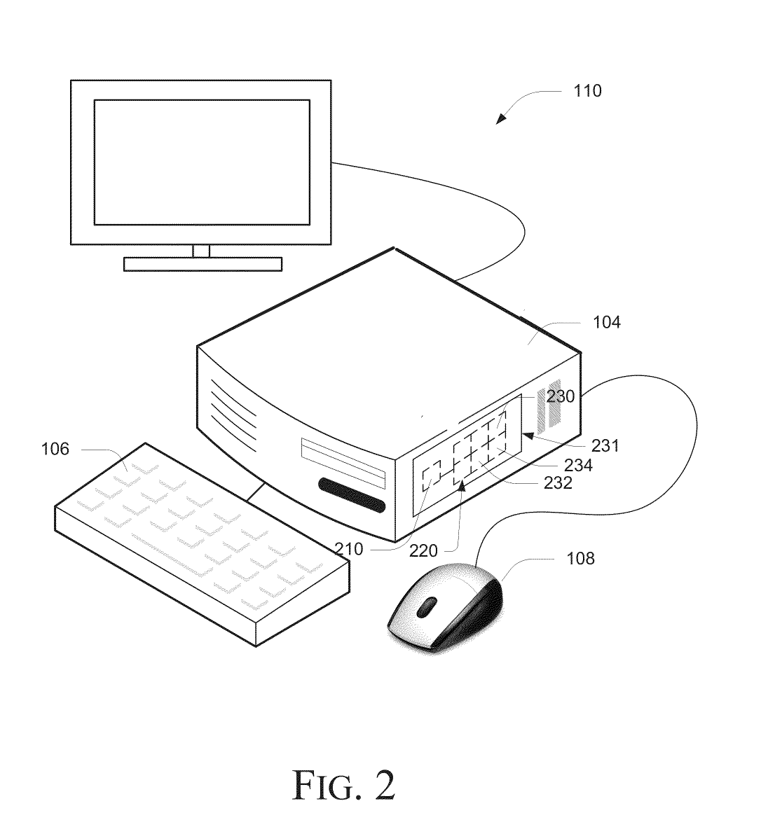

As can be seen in FIG. 2, apparatus 110 comprises computing device 204, a visual display device 202 and a data input device, such as for example and without limitation, a keyboard 206 and/or a mouse 208. In certain embodiments, visual display device 202 may be the same as the data input device, such as is seen with smart phones and tablets wherein the display screen is touch-sensitive. Computing device 204 comprises controller 231 comprising a programmable processor 210 interconnected via communication links with non-transitory computer readable medium 220, computer readable program code 230 encoded in the non-transitory computer readable medium 220, optional VOIP module 232, and optional “WI-FI” module 234. In certain embodiments, computing device 204, visual display device 202, and data input device are combined into a single hand-held device, such as a tablet PC, laptop computer, cellular telephone, or PDA.

In certain embodiments, visual display device 202 comprises a liquid crystal display (LCD) display, or a plasma display. In other embodiments, visual display device 202 comprises a video projector and screen.

In certain embodiments, non-transitory computer readable medium 220 comprises non-volatile memory. In certain embodiments, non-transitory computer readable medium 220 comprises battery backed up RAM, a magnetic hard disk assembly, an optical disk assembly, and/or electronic memory. By “electronic memory,” Applicant means a PROM, EPROM, EEPROM, SMARTMEDIA, FLASHMEDIA, and the like.

Optional VOIP module 232 implements a Voice over Internet Protocol (VoIP). VoIP is a general term for a family of transmission technologies for delivery of voice communications over IP SNSs such as the Internet or other packet-switched SNSs. Internet telephony includes communications services, such as and without limitation voice, facsimile, and/or voice-messaging applications that are transported via the Internet, rather than the public switched telephone SNS (PSTN).

Optional WI-FI module 234 comprises a wireless SNS communication module comprising a wireless SNS permitting communication with one or more external computers or programmable devices in a SNS or with point-to-point communications. In certain embodiments, WI-FI module 234 implements one or more of the embodiments of IEEE Specification 802.11 (collectively the “IEEE Specification”). As those skilled in the art will appreciate, the IEEE Specification comprises a family of specifications developed by the IEEE for wireless LAN technology.

The IEEE Specification specifies an over-the-air interface between a wireless client, such as for example apparatus 110(a) (FIG. 1), and a server or between two wireless clients. The IEEE accepted the IEEE Specification in 1997. There are several specifications in the 802.11 family, including (i) specification 802.11 which applies to wireless LANs and provides 1 or 2 Mbps transmission in the 2.4 GHz band using either frequency hopping spread spectrum (FHSS) or direct sequence spread spectrum (DSSS); (ii) specification 802.11 a which comprises an extension to 802.11 that applies to wireless LANs and provides up to 54 Mbps in the 5 GHz band using an orthogonal frequency division multiplexing encoding scheme rather than FHSS or DSSS; (iii) specification 802.11b, sometimes referred to as 802.11 High Rate or WI-FI, which comprises an extension to 802.11 that applies to wireless LANS and provides up to about 11 Mbps transmission in the 2.4 GHz band; and/or (iv) specification 802.11g which applies to wireless LANs and provides 20+Mbps in the 2.4 GHz band.

Processor 210 uses computer readable program code 230 to operate controller 231, WI-FI module 234, VOIP module 232, and visual display device 202.

While the foregoing description of FIG. 2 has been provided regarding the internet-enabled devices used by users to access Applicant's SNS 100, one of ordinary skill in the art will appreciate that the description is equally applicable to the internet-enabled devices 111(a)-111(c) used by professionals 109(a)-109(c) to access SNS 100. Furthermore, while internet-enabled device 110 is depicted in FIG. 2 as being a personal computer, one of ordinary skill in the art will appreciate that the description provided is equally applicable to other types of internet-enabled devices such as laptops, smart phones, tablets, PDAs, and the like.

Returning to FIG. 1A, user 108(a) uses internet-enabled apparatus 110(a) to access communication fabric 102. In certain embodiments, fabric 102 comprises, for example, one or more switches 104. In certain embodiments, those one or more switches 104 include one or more conventional router switches.

In certain embodiments, communication fabric 102 comprises an intranet. In certain embodiments, communication fabric 102 comprises a local area network. In certain embodiments, communication fabric comprises a wide area network. In certain embodiments, communication fabric 102 comprises the Internet.

User 108(a) uses internet-enabled apparatus 110(a) to communicate with users 108(a)-108(c) via communication fabric 102, wherein users 108(a)-108(c) are subscribers to Applicant's SNS 100 via SNS server 112. In certain embodiments, user 108(a) uses internet-enabled apparatus 110(a) to access communication fabric 101 to communicate with users 109(a) and 109(b), wherein users 1109(a) and 109(b) are not subscribers to Applicant's SNS 100 109(a)-109(c) and do not have access to SNS server 112. In certain embodiments, information may be transmitted to and from user 108(a)'s internet-enabled apparatus 110(a), and users 108(a)-(c) and 109(a), using optional Wi-Fi module 234, optional VOIP module 232, or any computing device capable of connecting to the internet such as a local-area network (LAN) or wide-area network (WAN).

Applicant's SNS server 112 comprises a programmable processor 114 interconnected via a communication link with non-transitory computer readable medium 116, and computer readable program code 118 encoded in non-transitory computer readable medium 116. One of ordinary skill in the art will appreciate that while FIG. 1 depicts a single server, in certain embodiments Applicant's SNS may comprise multiple servers without departing from the scope of the present invention.

In certain embodiments, non-transitory computer readable medium 116 comprises non-volatile memory. In certain embodiments, non-transitory computer readable medium 116 comprises battery backed up RAM, a magnetic hard disk assembly, an optical disk assembly, and/or electronic memory. By “electronic memory,” Applicant means a PROM, EPROM, EEPROM, SMARTMEDIA, FLASHMEDIA, and the like.

In the illustrated embodiment of FIG. 1, server 112 further comprises travel / lodging provider database 102, subscriber database 104, and services database 106. Member database 104 includes the personal information of each subscriber of SNS 100 including one or more of their name, telephone number, email, address, user type, and the like.

In certain embodiments, the databases resident on SNS server 112 recite contact information for various providers. Referring to FIG. 1B, Applicant's SNS server 112 is in communication, via communication fabric 102, with a plurality of providers, such as for example and without limitation travel services provider 130, lodging services provider 140, services provider 150, rental vehicle provider 160, state agency 170, federal agency 180 and catalog goods provider 190. In certain embodiments, each of the plurality of providers pay a services provider subscription fee to Applicant's SNS. In certain embodiments, such a services provider subscription fee is paid on a monthly basis. In certain embodiments, a services provider subscription fee is based upon SNS subscribers usage of services accessed through SNS server 112.

The various providers illustrated in FIG. 1B should not be taken as limiting. In addition, for the sake of clarity only a single example of travel provider, lodging provider, services provider, rental vehicle provider, state agency, federal agency, and catalog goods provider, are shown in FIG. 1B. The recitation of FIG. 1B should not be taken as limiting. In certain embodiments, Applicant's SNS server 112 is in communication with a plurality of travel services providers, including without limitation individual airlines, cruise lines, equine service providers, travel agencies, and the like. In certain embodiments, Applicant's SNS server 112 is in communication with a plurality of lodging services providers, including individual hostelries, regional associations, and world-wide providers.

In certain embodiments, Applicant's SNS server 112 is in communication with a plurality of rental vehicle providers, including without limitation local providers, regional car rental companies, and world-wide vehicle rental providers. In certain embodiments, Applicant's SNS server 112 is in communication with a plurality of state agencies, including without limitation parks departments, highway departments, law enforcement agencies and the like. In certain embodiments, Applicant's SNS server 112 is in communication with a plurality of federal agencies, including without limitation national park services, state departments, immigration services, and the like.

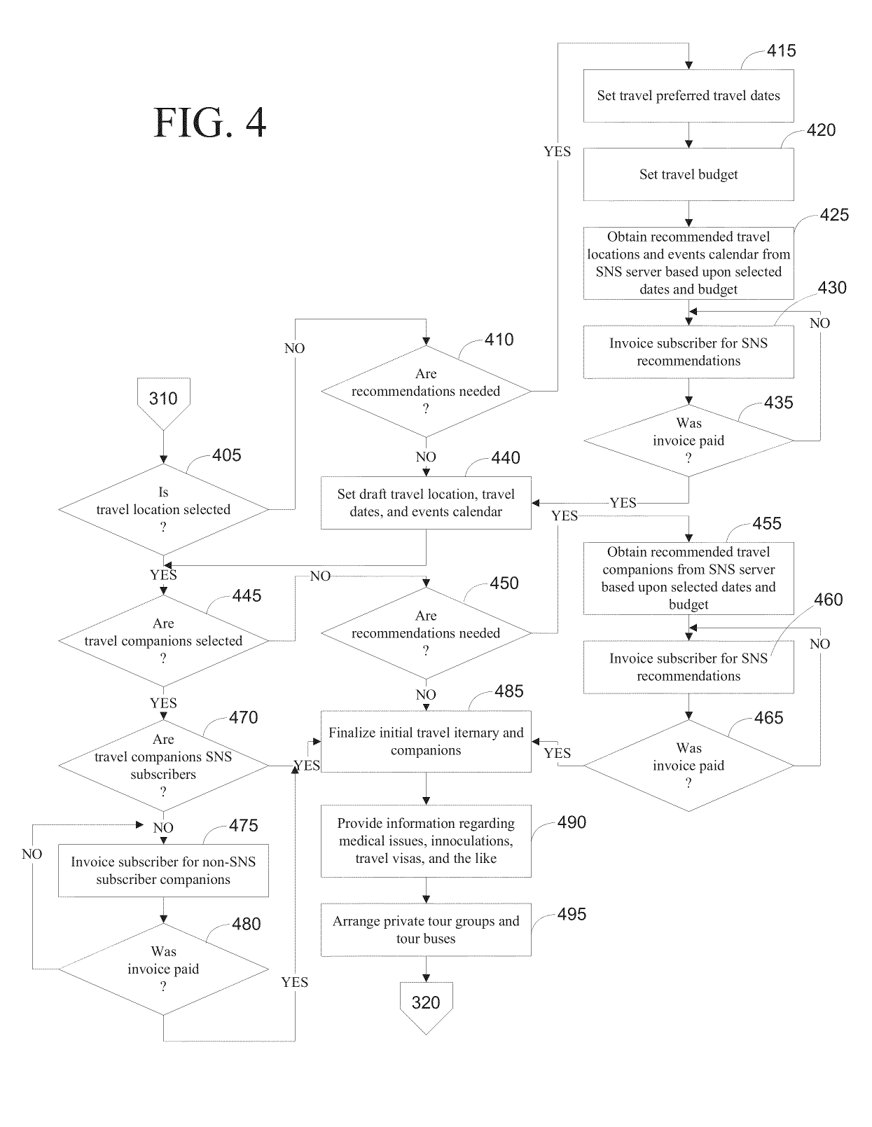

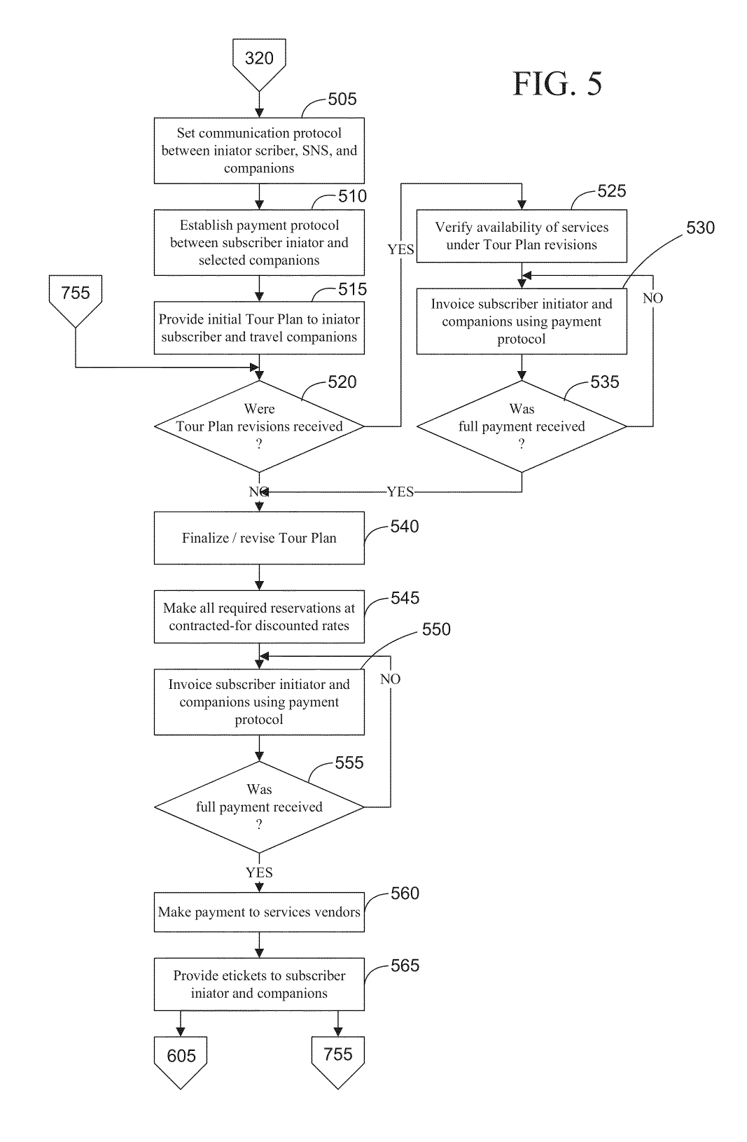

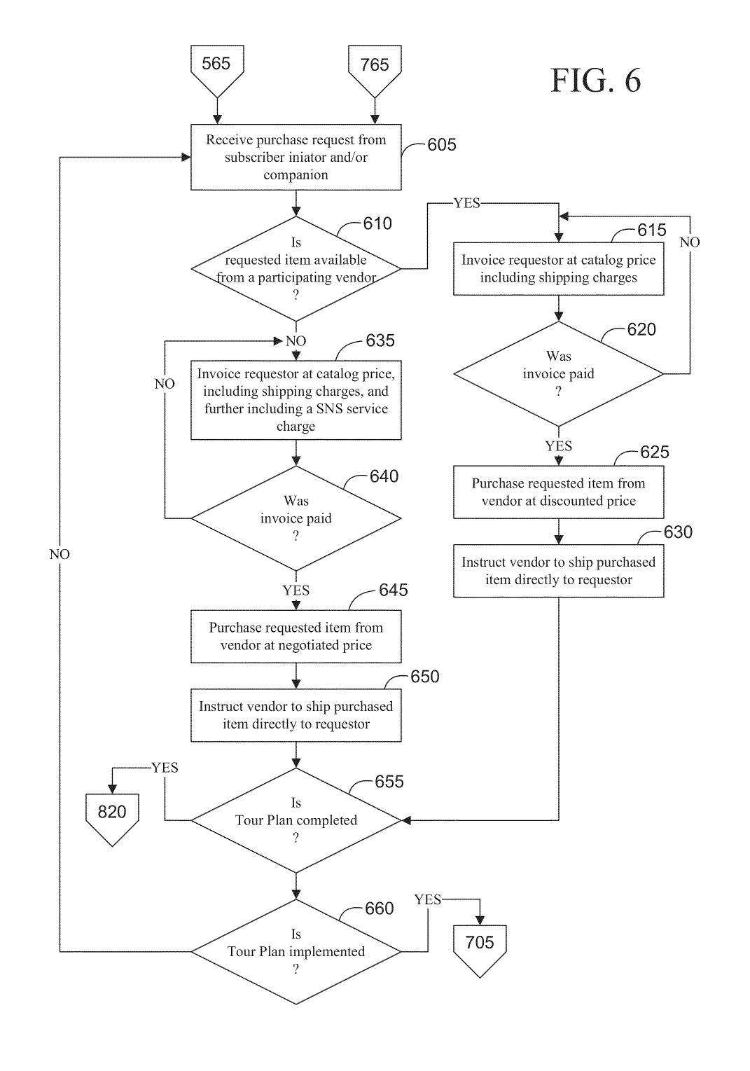

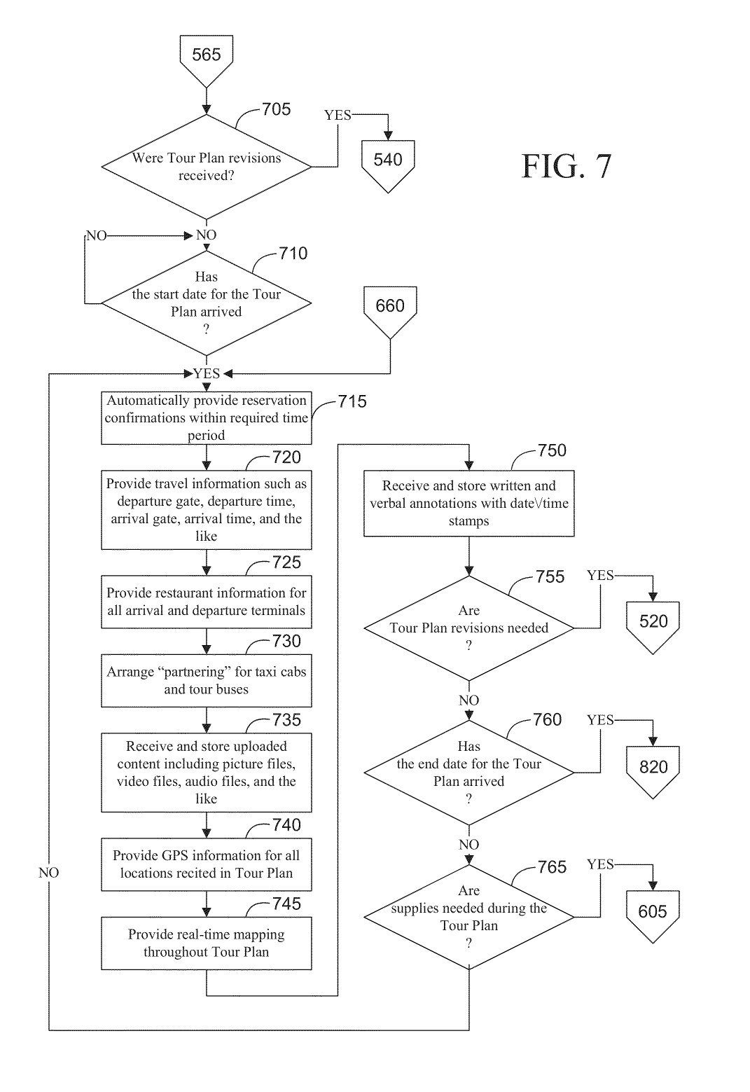

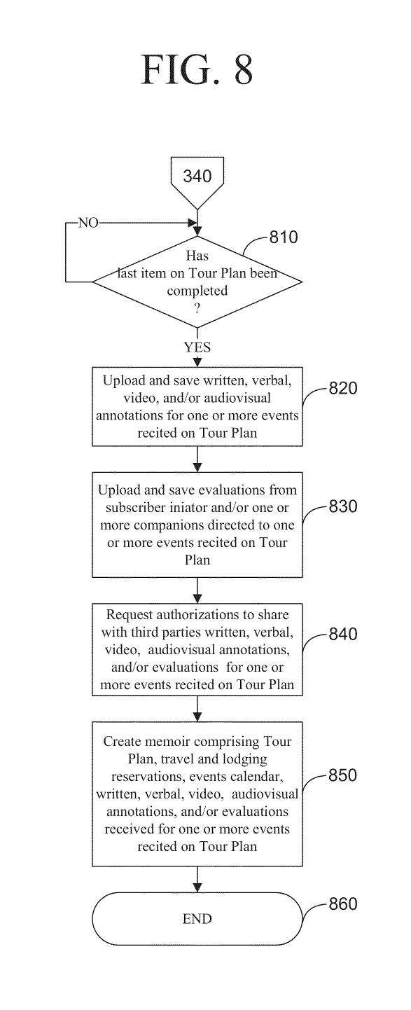

FIG. 3 illustrates an overview of one usage of Applicant's SNS. In the illustrated embodiment of FIG. 3, a SNS subscriber can initiate a Travel Plan at step 310, Revise that Travel Plan at step 320, make purchases related to the Travel Plan at step 330, Implement the Travel Plan at step 340, and Conclude the Travel Plan at step 350, using Applicant's SNS and method. In certain embodiments, step 310 comprises the steps recited in FIG. 4. In certain embodiments, step 320 comprises the steps recited in FIG. 5. In certain embodiments, step 330 comprises the steps recited in FIG. 6. In certain embodiments, step 340 comprises the steps recited in FIG. 7. In certain embodiments, step 350 comprises the steps recited in FIG. 8.

Referring now to FIG. 4, in step 405 the method determines whether a travel location has been selected. If the method determines in step 405 that a travel location has not been determined, then the method transitions from step 405 to step 410 wherein the method determines whether recommendations from Applicant's SNS are needed. If the method determines in step 410 that recommendations are needed, then the method transitions from step 410 to step 415 wherein the method sets preferred travel dates. In certain embodiments, the preferred travel dates are input from the subscriber initiator of the Tour Plan.

In step 420, the method sets a travel budget. In certain embodiments, the travel budget is determined by the subscriber initiator of the Tour Plan.

In step 425, the method provides recommended travel locations and a draft events calendar based upon the selected travel dates of step 415 and the budget of step 420.

In step 430, the method invoices the subscriber initiator for the SNS recommendations of step 425. In step 435, the method determines if the invoice of step 435 has been paid. If the method determines in step 435 that the invoice has not been paid then the method provides another invoice. If the method determines in step 435 that the invoice has been paid, then the method transitions from step 435 to step 440. In certain embodiments, depending on the subscriber initiator's membership level, the method omits steps 430 and 435.

In step 440, the method sets draft travel locations, travel dates, and an event calendar. The method transitions from step 440 to step 445 wherein the method determines if travel companions have been selected.

If the method determines in step 445 that travel companions have not been selected, then the method transitions from step 445 to step 450 wherein the method determines if recommended travel companions are needed. If the method determines in step 450 that travel companion recommendations are needed, then the method transitions from step 450 to step 455 wherein the method reviews the SNS subscriber database to identify recommended travel companions based upon the travel ternary, event calendar, and budget.

The method transitions from step 455 to step 460 wherein the method invoices the subscriber initiator for the SNS recommendations of step 455. In step 465, the method determines if the invoice of step 460 has been paid. If the method determines in step 465 that the invoice has not been paid then the method provides another invoice. If the method determines in step 465 that the invoice has been paid, then the method transitions from step 465 to step 485. In certain embodiments, depending on the subscriber initiator's membership level, the method omits steps 460 and 465.

If the method determines in step 405 that a travel location has been selected, then the method transitions from step 405 to step 445. If the method determines in step 445 that travel companions have been selected, then the method transitions from step 445 to step 470 wherein the method determines if the travel companions are SNS subscribers. If the method determines in step 470 that the selected travel companions are SNS subscribers, then the method transitions from step 470 to step 485.

If the method determines in step 470 that the selected travel companions are not SNS subscribers, then the method transitions from step 470 to step 475 wherein invoices the subscriber initiator for including non-SNS subscribers are travel companions. In step 480, the method determines if the invoice of step 475 has been paid. If the method determines in step 480 that the invoice has not been paid then the method provides another invoice. If the method determines in step 475 that the invoice has been paid, then the method transitions from step 4480 to step 485. In certain embodiments, depending on the subscriber initiator's membership level, the method omits steps 475 and 480.

In step 485, the method finalizes the travel ternary, including the events calendar and the travel companions. In step 490, the method provides to the subscriber initiator and to the travel companions information regarding medical issues, inoculations, travel visas, and the like.

In step 495, the method arranges private tour groups for the subscriber initiator and companions. In certain embodiments, the method associates the subscriber initiator and companions with third parties, and engages the services of tour operators to provide private tour services to the newly-formed tour group. The method transitions from step 4965 to step 320 (FIG. 3).

The method makes provisions for revisions to the Tour Plan of step 485. Referring now to FIG. 5, in step 505 the method sets a communication protocol between the subscriber initiator, selected travel companions, and the SNS server 112. In certain embodiments, any mode of communication is available, including without limitation, telephone, cellular telephone, satellite telephone, email, instant messaging, texting, and the like.

In step 510, the method establishes a payment protocol between the subscriber initiator and the travel companions. In certain embodiments, the payment protocol of step 510 comprises setting a percent payment allocation for the subscriber initiator and each of the travel companions. In certain embodiments, the payment protocol of step 510 comprises determining the currency, credit card, debit card, bank account, with which each of the subscriber initiator and each travel companions will satisfy his/her payment obligations.

In step 515, the method provides the initial Tour Plan to the subscriber initiator and the travel companions. In step 520, the method determines if Tour Plan revisions were received. If the method determines in step 520 that Tour Plan revisions were received and approved by the subscriber initiator and travel companions, then the method transitions from step 520 to step 525 wherein the method verifies the availability of services under the Tour Plan revisions. In step 530, the method invoices the subscriber initiator and the travel companions, using the payment protocol of step 510, for the SNS Tour Plan revisions of step 525. In step 535, the method determines if the invoice of step 530 has been paid. If the method determines in step 535 that the invoice has not been paid then the method provides another invoice. If the method determines in step 535 that the invoice has been paid, then the method transitions from step 535 to step 540. In certain embodiments, depending on the subscriber initiator's membership level, the method omits steps 530 and 535.

In step 540, the method finalizes/revises the Tour Plan. In step 545, the method makes all required reservations at contract-for discounted rates. In certain embodiments, the method negotiates discounted rates for all the service providers recited in FIG. 1B.

In step 550, the method invoices the subscriber initiator and the travel companions, using the payment protocol of step 510, for all phases of the travel itinerary, as finalized or revised in step 540. In step 555, the method determines if the invoice of step 550 has been paid. If the method determines in step 555 that the invoice has not been paid then the method provides another invoice. If the method determines in step 555 that the invoice of step 550 has been paid, then the method transitions from step 555 to step 560, wherein the method makes payment to the various service vendors in accord with the Tour Plan. In step 565, the method provides etickets to the subscriber initiator and travel companions using the communication protocol of step 505. The method transitions from step 565 to step 605, or alternatively if the steps of FIG. 5 were accessed from step 755, the method transitions to step 705.

Applicant's method makes provision for the purchase of supplies both prior to initiating the Tour Plan and after implementing the Tour Plan. Referring now to FIG. 6, in step 605 the method determines if a request for the purchase of supplies is received from the subscriber initiator or a travel companion.

In step 620, the method determines of the requested item is available from a participating vendor. If the method determines in step 610 that a participating vendor is available, then the method transitions from step 610 to step 615 wherein the method invoices the requestor at a regular catalog price, including shipping and handling charges. In certain embodiments, the subscriber initiator and all the traveling companions are invoiced using the payment protocol of step 510.

In step 640, the method determines if the invoice of step 635 was paid. If the method determines in step 640 that the invoice has not been paid, then the method provides another invoice. If the method determines in step 640 that the invoice of step 635 has been paid, then the method transitions from step 640 to step 645 wherein the method purchases the requested item of step 605 from a participating vendor at a negotiated price. In step 650, the method instructs the vendor to ship the purchased item directly to the requestor of step 605.

In step 655 the method determines if the Tour Plan is completed. If the method determines in step 655 that the Tour Plan is completed, then the method transitions from step 655 to step 820. If the method determines in step 655 that the Tour Plan is not completed, then the method transitions from step 655 to step 660 wherein the method determines if the Tour Plan has been initiated. If the method determines in step 660 that the Tour Plan has been initiated, then the method transitions from step 660 to step 705. Alternatively, if the method determines that the Tour Plan has not been initiated, then the method transition from step 660 to step 605.

If the method determines in step 610 that the requested item is not available from a Participating vendor, then the method transitions from step 610 to step 625 wherein the method invoices the requestor of step 605 at a catalog price including shipping and handling charges and a SNS service charge, wherein the service charge of step 615 is greater than the SNS service charge of step 635.

In step 620, the method determines if the invoice of step 615 was paid. If the method determines in step 620 that the invoice has not been paid, then the method provides another invoice. If the method determines in step 620 that the invoice of step 615 has been paid, then the method transitions from step 620 to step 625 wherein the method purchases the requested item of step 605 from a non-participating vendor at a negotiated price. In step 630, the method instructs the vendor to ship the purchased item directly to the requestor of step 605. The method transitions from step 630 to step 655 and proceeds as described herein.

Applicant's method provides information to the subscriber initiator throughout the Tour Plan. Referring now to FIG. 7, in step 705 the method determines if Tour Plan revisions were received. If the method determines in step 705 that Tour Plan revisions were received, then the method transitions from step 705 to step 540 and continues as described herein. If the method determines in step 705 that Tour Plan revisions were not received, then the method transitions from step 705 to step 710 wherein the method determines if the start date for the Tour Plan has arrived. If the method determines in step 705 that the start date has not arrived, then the method pauses until the start date arrives. Alternatively, if the method determines in step 710 that the start date has arrived, then the method transitions from step 710 to step 715 wherein the method automatically provides reservation confirmations within any applicable or required period of time.

In step 720, the method provides travel information such as and without limitation departure gate, departure time, arrival gate, arrival time, and the like. In certain embodiments, the information of step 720 is provided to the subscriber initiator and each travel companion using the communication protocol of step 505.

In step 725, the method provides restaurant information in real time for each Tour Plan location, including and without limitation for each departure terminal and each arrival terminal.

In step 730, the method arranges “partnering” for taxi cabs and tour buses in real time for each Tour Plan location. In step 735, the method receives and stores uploaded content from the subscriber initiator and each travel companion, wherein that content comprises without limitation picture files, video files, audio files, and the like.

In step 740, the method provides GPS data in real time for all locations recited in the Tour Plan. In step 745, the method provides in real time mapping for all travel through the Tour Plan.

In step 750, the method receives and stores written and verbal annotations with associated date and time stamps for content provided by the subscriber initiator and all travel companions.

In step 755, the method determines if Tour Plan revisions are needed. In certain embodiments, the Tour Plan revisions of step 755 are initiated by the subscriber initiator and/or the travel companions. In certain embodiments, the Tour Plan revisions are initiated by the method based upon information provided from third parties, such as and without limitation weather services, airline services, cruise services, road conditions, and the like. If the method determines that Tour Plan revisions are needed, then the method transitions from step 755 to step 520 and continues as described herein. If the method determines in step 755 that Tour Plan revisions are not required, then the method transitions from step 755 to step 760.

In step 760, the method determines of the end date for the Tour Plan has arrived. If the method determines that the end date has arrived, then the method transitions from step 760 to step 820. Alternatively, if the method determines that the end date has not arrived, then the method transitions from step 760 to step 765 wherein the method determines if supplies are needed during the Tour Plan. If the method determines in step 765 that supplies are needed, then the method transitions from step 765 to step 605 and continues as described herein. Alternatively, if the method determines that supplies are not needed, then the method transitions from step 765 to step 715 and continues as described herein.

Applicant's method includes activities that occur after the Tour Plan has been completed. Referring now to FIG. 8, in step 810 the method determines if the last item on the Tour Plan has been completed. If the method determines in step 810 that the last item on the Tour Plan has not been completed, then the method pauses until the last item on the Tour Plan has been completed. Alternatively, if the method determines in step 810 that the last item on the Tour Plan has been completed, then the method transitions from step 810 to step 820 wherein the method uploads and saves written, verbal, video, and/or audio visual annotations for one or more events recited on the Tour Plan.

In step 830, the method uploads and saves evaluations from the subscriber initiator and/or one or more travel companions directed to one or more events recited on the Tour Plan.

In step 840, the method requests authorization to share with third parties written, verbal, video, a audio visual annotations, and/or evaluations provided by the subscriber initiator and/or one or more travel companions.

In step 850, the method creates a memoir comprising the Tour Plan, travel and lodging reservations, events calendar, written, verbal, video, audio visual annotations, and/or evaluations received for one or more events recited on the Tour Plan

In certain embodiments, individual steps recited in FIGS. 3, 4, 5, 6, 7, and/or 8, may be combined, eliminated, or reordered.

In certain embodiments, instructions, such as instructions 118 (FIG. 1), are encoded in non-transitory computer readable medium, such as non-transitory computer readable medium 116 (FIG. 1), wherein those instructions are executed by a processor, such as processor 114 (FIG. 1), to perform one or more of the steps recited in FIGS. 3, 4, 5, 6, 7, and/or 8.

In yet other embodiments, the invention includes instructions residing in any other computer program product, where those instructions are executed by a computer external to, or internal to, a computing system to perform one or more of the steps recited in FIGS. 3, 4, 5, 6, 7, and/or 8 In either case the instructions may be encoded in a non-transitory computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, CompactFlash, SmartMedia, and the like.

While the preferred embodiments of the present invention have been illustrated in detail, it should be apparent that modifications and adaptations to those embodiments may occur to one skilled in the art without departing from the scope of the present invention.

We claim:

1. A social networking system server comprising a processor, a non-transitory computer readable medium, computer readable program code encoded in said non-transitory computer readable medium, wherein said wherein said processor utilizes said computer readable program code to design, implement, and conclude, a travel plan, the computer readable program code comprising a series of computer readable program steps to effect:
coordinating a global, on-line social networking system (“SNS”) comprising one or more global lodging providers in on-line communication with said SNS server, one or more global travel services providers in on-line communication with said SNS server, one or more global rental vehicle service providers in on-line communication with said SNS server, one or more global catalog goods providers in on-line communication with said SNS server, and a plurality of individual SNN members in on-line communication with said SNS server;
initiating a travel plan for a first SNS member;
purchasing goods on-line;
implementing a tour plan; and
concluding said tour plan.

2. The social networking system server of claim 1, wherein said computer readable program code to initiate a travel plan further comprises a series of computer readable program steps to effect:
determining preferred travel dates;
setting a travel budget;
recommending travel locations and events based upon said preferred travel dates and travel budget;
invoicing said first SNS member for said recommendations.

3. The social networking system server of claim 2, wherein said computer readable program code to initiate a travel plan further comprises a series of computer readable program steps to effect:
recommend travel companions based upon said preferred travel dates and travel budget;
determining if said recommended travel companions are non-SNS subscribers;
if said recommended travel companions are non-SNS subscribers, invoicing said first SNS member for making said travel companion recommendations.

4. The social networking system server of claim 3, wherein said computer readable program code to initiate a travel plan further comprises a series of computer readable program steps to effect:
setting a communication protocol between said first SNS member, said SNS server, and said recommended travel companions;
setting a payment protocol between said first SNS member, said SNS server, and said recommended travel companions;
finalizing a tour plan comprising a travel itinerary and travel companions;
providing information to said first SNS member and said travel companions selected from the group consisting of medical information and travel visa information.
arranging private tour groups based upon said tour plan;
arranging tour buses based upon said tour plan;

5. The social networking system server of claim 4, wherein said computer readable program code to initiate a travel plan further comprises a series of computer readable program steps to effect:
making required reservations based upon said tour plan at previously contracted-for, discounted rates for said tour plan;
invoicing said first SNS member and said travel companions using said payment protocol;
if full payment was received from said SNS member and travel companions, making payments to services vendors;
providing etickets to said first SNS member and said travel companions.

6. The social networking system server of claim 1, wherein said computer readable program code to purchase goods further comprises a series of computer readable program steps to effect:
receiving a purchase request from a requestor selected from the group consisting of said SNS member, and said travel companions;
invoicing requestor at a catalog price for said goods;
if a goods invoice is paid, purchasing said goods from a vendor at a previously negotiated price;
instructing vendor to ship goods directly to requestor.

7. The social networking system server of claim 1, wherein said computer readable program code to implement a tour plan further comprises a series of computer readable program steps to effect:
providing reservation confirmations within a required time period;
providing travel information selected from the group consisting of departure gate, departure time, arrival gate, and arrival time.

8. The social networking system server of claim 1, wherein said computer readable program code to implement a tour plan further comprises a series of computer readable program steps to effect:
scheduling taxi cabs; and
scheduling tour buses.

9. The social networking system server of claim 1, wherein said computer readable program code to implement a tour plan further comprises a series of computer readable program steps to effect:
receiving and storing uploaded content from said first SNS member and said travel selected from the group consisting of picture files, video files, and audio files;
providing GPS information for locations recited in said tour plan; and
providing real-time mapping throughout said tour plan.

10. The social networking system server of claim 1, wherein said computer readable program code to conclude a tour plan when a last item on said tour plan has been completed, further comprises a series of computer readable program steps to effect:
uploading and saving annotations for one or more events recited on said tour plan, wherein said annotations are selected from the group consisting of written annotations, verbal annotations, video annotations, and audiovisual annotations;
uploading and saving evaluations received from said first SNS member and said travel companions;
requesting authorization to share with third parties said annotations and said evaluations;
creating a memoir comprising said tour plan, travel and lodging reservations, an events calendar, said annotations, and said evaluations.

11. A computer program product encoded in a non-transitory computer readable medium, wherein a programmable computer processor can utilize said computer program product to initiate a travel plan and implement and conclude a tour plan based upon said travel plan, comprising:
computer readable program code which causes said programmable computer processor to coordinate a global, on-line social networking system (“SNS”) comprising one or more global lodging providers in on-line communication with said SNS server, one or more global travel services providers in on-line communication with said SNS server, one or more global rental vehicle service providers in on-line communication with said SNS server, one or more global catalog goods providers in on-line communication with said SNS server, and a plurality of individual SNN members in on-line communication with said SNS server;
computer readable program code which causes said programmable computer processor to initiate a travel plan for a first SNS member;
computer readable program code which causes said programmable computer processor to purchase goods on-line;
computer readable program code which causes said programmable computer processor to implement a tour plan; and
computer readable program code which causes said programmable computer processor to conclude said tour plan.

12. The computer program product of claim 11, wherein said computer readable program code to initiate a travel plan further comprises:
computer readable program code which causes said programmable computer processor to determine preferred travel dates;
computer readable program code which causes said programmable computer processor to set a travel budget;
computer readable program code which causes said programmable computer processor to recommend travel locations and events based upon said preferred travel dates and travel budget;
computer readable program code which causes said programmable computer processor to invoice said first SNS member for said recommendations.

13. The computer program product of claim 11, wherein said computer readable program code to initiate a travel plan further comprises:
computer readable program code which causes said programmable computer processor to recommend travel companions based upon said preferred travel dates and travel budget;
computer readable program code which causes said programmable computer processor to determine if said recommended travel companions are non-SNS subscribers;
computer readable program code which, if said recommended travel companions are non-SNS subscribers, causes said programmable computer processor to invoice said first SNS member for making said travel companion recommendations.

14. The computer program product of claim 13, wherein said computer readable program code to initiate a travel plan further comprises:
computer readable program code which causes said programmable computer processor to set a communication protocol between said first SNS member, said SNS server, and said recommended travel companions;
computer readable program code which causes said programmable computer processor to set a payment protocol between said first SNS member, said SNS server, and said recommended travel companions;
computer readable program code which causes said programmable computer processor to finalize tour plan comprising a travel itinerary and travel companions;
computer readable program code which causes said programmable computer processor to provide information to said first SNS member and said travel companions selected from the group consisting of medical information and travel visa information.
computer readable program code which causes said programmable computer processor to arrange private tour groups based upon said tour plan;
computer readable program code which causes said programmable computer processor to arrange tour buses based upon said tour plan;

15. The computer program product of claim 11, wherein said computer readable program code to initiate a travel plan further comprises:
computer readable program code which causes said programmable computer processor to make reservations based upon said tour plan at previously contracted-for, discounted rates;
computer readable program code which causes said programmable computer processor to invoice said first SNS member and said travel companions using said payment protocol;
computer readable program code which, if full payment was received from said SNS member and travel companions, causes said programmable computer processor to make payments to services vendors;
computer readable program code which causes said programmable computer processor to provide etickets to said first SNS member and said travel companions.

16. The computer program product of claim 11, wherein said computer readable program code to purchase goods further comprises:
computer readable program code which causes said programmable computer processor to receive a purchase request from a requestor selected from the group consisting of said SNS member, and said travel companions;
computer readable program code which causes said programmable computer processor to invoice said requestor at a catalog price for said goods;
computer readable program code which, if a goods invoice is paid, causes said programmable computer processor to purchase said goods from a vendor at a previously negotiated price;
computer readable program code which causes said programmable computer processor to instruct said vendor to ship goods directly to requestor.

17. The computer program product of claim 11, wherein said computer readable program code to implement a tour plan further comprises:
computer readable program code which causes said programmable computer processor to provide reservation confirmations within a required time period;
computer readable program code which causes said programmable computer processor to provide travel information selected from the group consisting of departure gate, departure time, arrival gate, and arrival time.

18. The computer program product of claim 11, wherein said computer readable program code to implement a tour plan further comprises:
computer readable program code which causes said programmable computer processor to schedule taxi cabs based upon said tour plan; and
computer readable program code which causes said programmable computer processor to schedule tour buses based upon said tour plan.

19. The computer program product of claim 11, wherein said computer readable program code to implement a tour plan further comprises:
computer readable program code which causes said programmable computer processor to receive and store uploaded content from said first SNS member and said travel selected from the group consisting of picture files, video files, and audio files;
computer readable program code which causes said programmable computer processor to provide GPS information for locations recited in said tour plan; and
computer readable program code which causes said programmable computer processor to provide real-time mapping throughout said tour plan.

20. The computer program product of claim 11, wherein said computer readable program code to conclude a tour plan when a last item on said tour plan has been completed, further comprises:
computer readable program code which causes said programmable computer processor to upload and save annotations for one or more events recited on said tour plan, wherein said annotations are selected from the group consisting of written annotations, verbal annotations, video annotations, and audiovisual annotations;
computer readable program code which causes said programmable computer processor to upload and save evaluations received from said first SNS member and said travel companions;
computer readable program code which causes said programmable computer processor to request authorization to share with third parties said annotations and said evaluations;
computer readable program code which causes said programmable computer processor to create a memoir comprising said tour plan, travel and lodging reservations, an events calendar, said annotations, and said evaluations.
